(19) United States
(12) Patent Application Publication
(10) Pub. No.: US 2003/0129293 A1
(43) Pub. Date: Jul. 10, 2003

(54) Method and apparatus for preparing a mixture

(76) Inventor: Charles P. Wood JR., Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/043,448

(22) Filed: Jan. 10, 2002

(51) Int. Cl. C12G 1/00

(52) U.S. Cl. 426/592

(57) ABSTRACT

A novel measuring and mixing gauge and method of preparing and mixing a liquid mixture whereby liquid mixtures having two or more liquid ingredients may be consistently and repeatedly prepared and mixed. The measuring and mixing gauge generally comprises a portable gauge that is placed within the mixing container having a vertically orientated member. Positioned on the vertical member are selectively movable indices indicating the level to which the liquid ingredients are sequentially added to the container. The gauge may also be used to thoroughly mix the ingredients within the container.

### FIELD OF THE INVENTION

The present invention relates to a method and apparatus for preparing and mixing a mixture having more than one ingredient that must be mixed in a given volumetric relationship. More particularly, the present invention relates to a method and apparatus for consistently, and repeatedly, dispensing measured amounts of ingredients for preparing an alcoholic, or nonalcoholic, drink having a given recipe.

### BACKGROUND OF THE INVENTION

There has been a long felt need for a simple, inexpensive and accurate device whereby a person may successively and consistently prepare a mixed drink in accord with a given recipe. More particularly, there has been a long felt need for a single device that may be used to simply, successively and accurately prepare mixed drinks having varying recipes.

Although such a device would be useful for a host of applications, it is particularly useful for the casual home entertainer, who having little or no knowledge of how to properly prepare a mixed drink, may have requests, from guests, for a wide variety of mixed alcoholic drinks.

FIG. 1 illustrates a container, or glass, that is known to be used for preparing and/or serving “Irish Coffee.” The container typically has lines “a” and “b” inscribed thereon. The user first adds the required dry ingredients, such as sugar, followed by Irish Whiskey to the first level, “a.” Then a coffee brew is added, raising the mixture level to the second level, “b.” The mixture is then stirred and whipped cream added atop the mixture.

Although a similar type of graduated, or calibrated, container, or glass, might be used for preparing any one of a variety of alcoholic mixed drinks, a separate graduated container would be required for each of the many mixed drink recipes that exist, as each recipe has a varying number of ingredients in varying proportions. Thus, a device is provided to allow for the mixing of drinks with varying numbers and proportions of ingredients.

### SUMMARY OF THE INVENTION

The present invention overcomes the problems with the prior art by providing a single measuring and mixing device that is independent of the mixing container. This permits the user to vary the proportions of the mixed ingredients to suit individual tastes and/or vary the proportions of the ingredients in accord with the recipes of different mixed drinks. The measuring and mixing device is particularly useful in assisting the novice in the preparation and mixing of alcoholic and/or non-alcoholic mixed drinks. However, other uses may be made of the device.

In one embodiment, a combination measuring and mixing gauge is described and taught herein, that comprises a generally planar base having a perpendicular measuring rod projecting upward therefrom. The rod has movable bands, or indices, that may be positioned at any desired location along the height of the rod. The first band is set at a height representing the volume of the first ingredient; the second is set at a height for the combined volume of the second ingredient to be added to the first. The third band is set at the level of the combined volumes of the first and second ingredients plus the third and so forth, thereby accounting for all required ingredients. Commonly, the ingredients are liquid; however, this invention is useful for ingredients of any type (i.e., liquid, fluid, granular, solid, etc.), provided they can be measured on a volumetric basis. Any dry ingredients, such as dissolvable ingredients, may be added at any time during the preparation of the drink mixture.

The supporting base of the measuring gauge is provided with a structure whereby the measuring gauge also doubles as a mixing device to mix the ingredients once placed in the mixing container.

Once the bands are set at their appropriate position on the measuring rod, the measuring and mixing gauge is placed in the container, and the ingredients are added in the proper sequence until the level of the mixture reaches the appropriate band. Once all ingredients are added to the container, the ingredients are mixed by moving the measuring and mixing gauge up and down, and/or in a rotating motion. After the drink is thoroughly mixed, the measuring and mixing gauge is removed from the container to be used again for mixing additional drinks of the same recipe or the bands may be reset for preparation of a mixed drink having a different recipe.

The above and other objects and advantages of the present invention will be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the present invention.

FIG. 1 is a perspective view of a typical prior art measuring and mixing container.

FIG. 2 is a perspective view of an exemplary mixing container having a measuring and mixing gauge in accordance with the present invention.

FIG. 3 is a perspective view of a measuring and mixing gauge in accordance with the present invention.

FIG. 4 is a cross-sectional view of a measuring and mixing gauge as taken along line 4-4 in FIG. 3.

FIG. 5 is an enlarged cross-sectional view of the circled area in FIG. 4 illustrating an alternate method of constructing the measuring and mixing gauge illustrated in FIGS. 3 and 4.

FIG. 6 is a cross-sectional view of the base of the measuring and mixing gauge taken along line 6-6 in FIG. 3.

FIG. 7 is a perspective view of an alternate base for the invention as illustrated in FIGS. 2 and 3 wherein the base comprises a multiple number of equally spaced mixing blades.

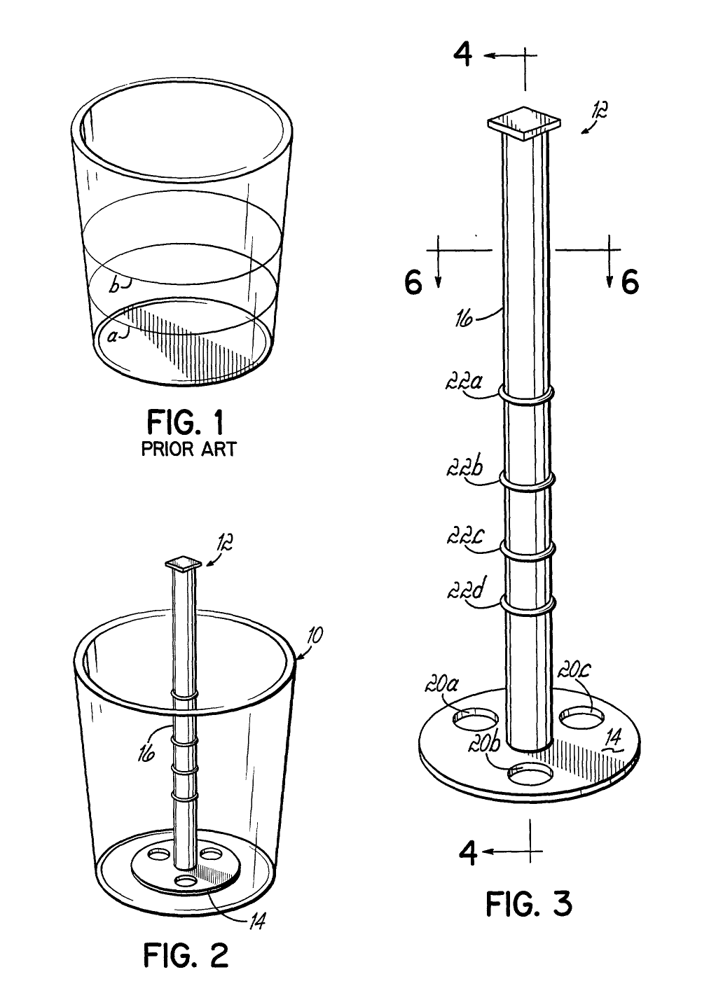

### DETAILED DESCRIPTION OF THE INVENTION

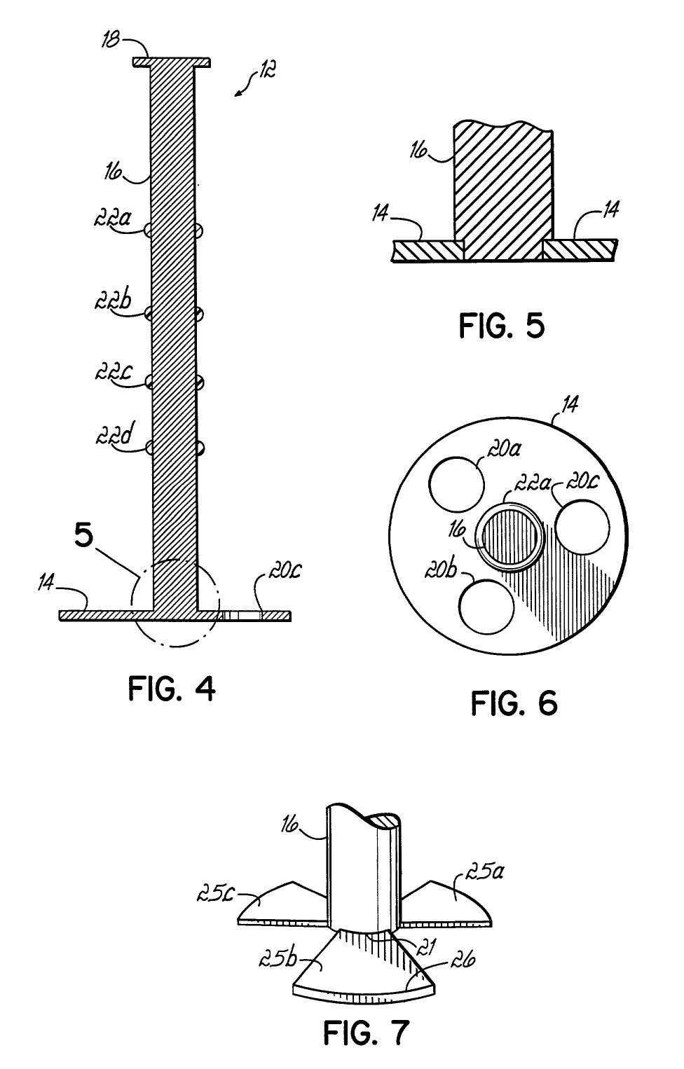

FIG. 2 provides an illustration of a typical mixed drink mixing container, or glass, 10 having a combination mixing and measuring gauge 12 positioned therein. Referring now to FIGS. 3 and 4, mixing gauge 12 comprises a base 14 having a perpendicular measuring rod 16 attached thereto. The base 14 and measuring rod 16 are preferred to be one integral piece, however, it may also be manufactured as two separate parts and assembled by any known and acceptable method. One such alternate construction is illustrated in FIG. 5. Base 14 preferably includes one or more apertures, or openings 20 therein, the function of which is further explained below.

Slidably positioned on rod 16 is a multiplicity of one or more indexing bands 22a, 22b, 22c, and 22d. Indexing bands 22 are typically held in place by frictional contact with rod 16 and may be conveniently positioned vertically on rod 16 by the user. Detents (not shown) may be included on the rod 16 for releasably retaining the indexing bands 22a-22d in desired locations on rod 16.

A top crown 18, of any desired configuration, may be separately attached, or integrally molded with rod 16, to function as a convenient means for the user to grip the mixing gauge between the fingers of the user's hand. Top crown 18 may be flat, as illustrated, or take the form of a knob like structure, or may be shaped in the form of any desired commercial logo, icon or trademark.

In the preferred embodiment, as illustrated in FIGS. 2 through 4, measuring and mixing gauge 12 is typically manufactured from a clear or translucent plastic material. However, any other suitable material may be used. Rod 16 is preferably round in cross-section, as illustrated in FIG. 4 or might alternatively be configured with any other desired cross-sectional configuration such as a hexagon or any other desired polynomial figure.

In the preferred embodiment, bands 22a through 22d are elastic O-rings typically manufactured from an elastomeric neoprene rubber type material and sized to frictionally engage, or grip, rod 16, such that bands 22a-22d may be slidably positioned at any desired location along the length of rod 16.

Base 14 typically comprises a circular disc, manufactured from a plastic material similar to that of rod 16. Positioned in base 14 are one or more openings, or apertures 20 as illustrated in FIG. 6. Although base 14 is preferably a circular disc, base 14 might also be configured as any desired planar figure such as a polynomial having any desired number of sides. Alternatively, base 14 might be configured as any desired commercial logo, icon or trademark.

In operation, measuring and mixing gauge 12 is used to assist the user in consistently preparing a mixed drink, alcoholic or otherwise, wherein more than one measured liquid or other ingredient is placed in a mixing container, or glass, and mixed together. Prior to being placed in the glass, the user positions bands 22a-22d at desired intervals along rod 16 proportional to the volume of each ingredient to be placed in the drink. Band 22d is positioned at the level to which the first ingredient is to be filled; band 22c is then positioned at the level which represents the combined volume of the first ingredient plus the volume of the second ingredient; band 22b is then positioned at the level representing the combined volumes of the first two ingredients plus the volume of the third ingredient and so on until all ingredients are represented on the gauge.

Measuring and mixing gauge 12 is then placed in the glass, or mixing container and each ingredient is then sequentially added to the glass until the level of the mixture rises to the appropriate band. Once all ingredients are added to the glass, measuring and mixing gauge 12 is then used to thoroughly mix the ingredients by alternately raising and lowering and/or simultaneously rotating the mixing gauge within the glass.

To assist the mixing of the drink ingredients, base 14 may be replaced by one or more, preferably three, mixing blades 25a, 25b, and 25c as illustrated in FIG. 7. Blades 25 may be planar, or they may have an angular twist or “washout” imparted to them from their root 21 to their outer periphery 26. The mixing blades might alternatively be rotatingly attached to rod 16 whereby the blades may rotate as the measuring and mixing gauge is raised and lowered within the mixture.

In yet another embodiment, once all ingredients are added to the glass, the glass is then covered, such as with a lid. To assist the mixing of the drink ingredients, the container can then be shaken. Thus, there would be no need for a mixing means on the base of the measuring and mixing gauge. The measuring and mixing gauge could also be removed prior to shaking.

By way of example, if the user is preparing a martini, using the present invention, band 22d would be placed at the desired level of the first ingredient, gin. Band 22c would be placed at the level representing the combined volume of gin plus the desired volume of the second ingredient, vermouth. Gin would then be added to the level of the first band 22d, followed by the addition of vermouth until the level within the container 10 rose to the level of band 22c. Thus, following this simple procedure a duplicate mixture of martini may be repeated time after time. If the user desired to change the proportions of gin and vermouth, the bands 22d and 22c may be adjusted to suit individual tastes. Subsequently, if and when the user desires to prepare a drink having a different recipe, bands 22a through 22d may be repositioned to accommodate the recipe of the new mixed drink.

Although the container within which the mixture is being prepared is preferably straight walled, the diameter of the container is unimportant as the volumetric proportions of the various liquid ingredients are linearly represented on measuring rod 16 by way of the indexing bands. Therefore, regardless of the diameter of the container, the proper volumetric relationship of the ingredients will be present when using the present invention.

Although the present invention has been described for use in preparing and mixing alcoholic and nonalcoholic drinks, the present invention may be used for any purpose requiring the consistent, and repeated, mixing of formulated mixtures. For example, the present invention might be used to mix paint with a thinning agent to repeatedly prepare a paint mixture. The present invention might further be used to mix dry ingredients such as flour, sugar, salt, etc.

Linear graduations, such as inches or centimeters, might be placed on rod 16 to assist the user in selectively placing bands 22. Thus, by way of example, if the user desired to prepare a 4 to 1 mixture of ingredients, such as a gasoline and oil mixture for use in a two-cycle engine, the first band 22d would be placed at the 10-cm mark and the second band 22c would be placed at the 50-cm mark. Oil would be poured into the container to the level of the first band 22d, and gasoline would then be added to the level of the second band 22c. Upon mixing, the user would have a 4 to 1 mixture of gasoline and oil. Adjustments can be made as appropriate depending upon the size/configuration of the mixing container.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to one skilled in the art. The invention in its broader aspects is therefore not limited to the specific details, representative apparatus and method, and illustrative examples shown and described. Accordingly, departures may be made from such details without departing from the spirit or scope of applicant's general inventive concept.

What is claimed is:

1. A gauge for measuring ingredient portions of a mixture having at least two ingredients comprising:
a base for supporting said apparatus in an open top mixing container;
an elongate member attached to said base; and
a plurality of movable indices attached to said elongate member.

2. The gauge of claim 1 wherein said base includes means for mixing said mixture.

3. The gauge of claim 1 wherein said base comprises a circular disc having at least one aperture therein.

4. The gauge of claim 1 wherein said base comprises at least one mixing blade.

5. The gauge of claim 1 wherein said indices comprise elastomeric bands.

6. The gauge of claim 1 wherein said elongate member comprises a cylindrical rod.

7. The gauge of claim 1 further comprising scaled graduations on said elongate member.

8. In combination:
an open top container; and
a measuring gauge for measuring the proportionate volumes of a plurality of ingredients, said measuring gauge comprising:
(a) a supporting base for supporting said gauge within said container whereby said gauge is free standing within said container;
(b) an elongate member attached to said supporting base whereby said elongate member extends upwardly through the interior of said container; and
(c) a measuring mechanism on said elongate member for measuring the level of said ingredients within said container.

9. The combination of claim 8 further comprising:
a mixing mechanism integral with said supporting base for mixing said ingredients within said container.

10. The combination of claim 8 wherein said measuring mechanism on said elongate member for measuring said level within said container comprises a multiplicity of movable indices slidably mounted on said elongate member.

11. The combination of claim 10 wherein said movable indices comprise elastomeric bands circumscribing said elongate member.

12. The combination of claim 8 wherein said mixing mechanism comprises at least one aperture in said base.

13. The combination of claim 8 wherein said base and said mixing mechanism combine to form at least one mixing blade, said blade extending radially outward from an axis of said elongate member.

14. A method of preparing a mixture having at least two ingredients therein, the method comprising:
providing an open top container;
providing a measuring gauge comprising a supporting base having an upwardly extending elongate member, said elongate member having multiple indices selectively positionable along the length thereof;
sequentially positioning said indices on said elongate member, whereby the position of each indice represents the level of a given ingredient plus the combined levels of all ingredients previously added to the container;
placing said measuring gauge within said container; and
sequentially adding said ingredients to said container until the level of the mixture therein rises to the level of that ingredient's associated indice.

15. The method of claim 14 further comprising:
moving said measuring gauge with a vertical reciprocating motion to thereby thoroughly mix the aggregate of ingredients.

16. The method of claim 14 further comprising:
rotating said measuring gauge to thereby thoroughly mix the aggregate of ingredients.

17. The method of claim 14 further comprising:
moving said measuring gauge with a vertical reciprocating motion and simultaneously rotating said measuring gauge to thereby thoroughly mix the aggregate of ingredients.

18. The method of claim 14 further comprising:
placing a lid on said container; and
shaking said container to thereby thoroughly mix the aggregate of ingredients.

19. The method of claim 14 further comprising:
removing said measuring gauge from said container;
repositioning said indices on said elongate member for a different mixture;
placing said measuring gauge in a second container; and
preparing said different mixture in said second container.
